(19) United States
(12) Patent Application Publication
(10) Pub. No.: US 2005/0272466 A1
(43) Pub. Date: Dec. 8, 2005

(54) Selection of wireless local area network (WLAN) with a split WLAN user equipment

(75) Inventors: Henry Haverinen, Jyvaksyla (FI); Pasi Eronen, Helsinki (FI)

Correspondence Address: FOLEY & LARDNER, 321 NORTH CLARK STREET, SUITE 2800, CHICAGO, IL, 60610-4764, US

(73) Assignee: Nokia Corporation

(21) Appl. No.: 11/120,831

(22) Filed: May 3, 2005

Related U.S. Application Data
(60) Provisional application No. 60/568,074, filed on May 3, 2004.

(51) Int. Cl. H04M 1/66

(52) U.S. Cl. 455/552.1

(57) ABSTRACT

A method, program product and system of selecting a wireless local area network (WLAN) using split user equipment. The method comprising the following steps: a first user equipment obtains relevant network selection parameters from a second user equipment and obtains an undecorated root network access identifier from the second user equipment, the first user equipment performs network discovery and selection, and, upon initiation of final EAP authentication, the first user equipment decorates said network access identifier and transmits it to the WLAN.

### BACKGROUND OF THE INVENTION

A. Field of the Invention

The present invention is directed to systems and methods for wireless network communications, and specifically to the selection of a network in the split user equipment case.

B. Background

3rd Generation Partnership Project (3GPP) wireless local area network (WLAN) interworking specifies several different interworking scenarios. Scenario 2 specifies, among other things, network access authentication based on the Extensible Authentication Protocol (EAP). Specifically, Scenario 2 specifies network discovery, network selection and Subscriber Identity Module (SIM) or Universal Mobile Telecommunications System Subscriber Identity Module (USIM) based network access authentication based on EAP-SIM and EAP-AKA (authentication and key agreement) protocols.

Network selection in 3GPP WLAN scenario 2 includes two inter-related steps. The first is the selection of a Wireless Local Area Network (WLAN) radio network. The second is the selection of the preferred “first-hop” Public Land Mobile Network (PLMN), if several PLMNs are available via the radio network. In the currently assumed network selection procedure, the terminal may need to go through all available radio networks in order to determine whether the home PLMN is available via some of the radio networks. Only after enumerating the available WLAN radio networks and the connected PLMNs, is the terminal able to select the radio network to join and the PLMN to use.

In IEEE 802.11 networks, WLAN radio network discovery is based on the scanning procedures and based on the Service Set Identifier (SSID) parameter. PLMN discovery and selection can be implemented using Extensible Authentication Protocol (EAP) Identity Request and Identity Response messages. Alternatively, future link layers might provide network information at layer-2 before EAP authentication is started. Even though the current working assumption and 3GPP release 6 use EAP identity messages for network discovery, this might change in the future. There are new activities in IEEE to specify more elaborate network advertisement at layer 2. However, it is expected that the selected visited PLMN will still be indicated by decorating the Network Access Identifier (NAI) that is included in the EAP Identity Response.

The 3GPP terminal, or the smart card inserted in the terminal, may contain the operator's or user's lists of preferred visited public land mobile networks (VPLMNs) or service set identifiers (SSIDs), and other possible network selection parameters, which are used during network selection.

Authentication in WLAN scenario 2 is based on the Extensible Authentication Protocol (EAP). EAP-SIM and EAP-AKA are EAP methods based on 3GPP 2G and 3G Authentication and Key agreement, respectively. EAP-SIM and EAP-AKA protocols are specified in www.ietf.org/internet-drafts/draft-haverinen-pppext-eap-sim-13.txt and www.ietf.org/internet-drafts/draft-arkko-pppext-eap-aka-12.txt.

In the so called “split UE” cases, the user equipment consists of two separate devices, such as a WLAN-enabled laptop and a mobile phone that contains a smart card. When SIM or USIM based WLAN network access authentication is performed, the smart card and the phone are involved in the authentication exchange over a local Bluetooth link or some other local link technology such as USB, serial cable, or WLAN. In one scenario, the laptop relays EAP requests it receives from the WLAN network to the phone over Bluetooth. The phone and the smart card process the EAP request, generate an appropriate EAP Response packet, and send the response packet to the laptop over Bluetooth. The laptop further relays the EAP responses to the WLAN network.

When the phone implements EAP-SIM and EAP-AKA protocols, the EAP-based network selection becomes a problem. EAP peer is implemented by the phone, while the WLAN interface is included in the laptop. In the existing systems, it is not clear how the split UE would perform WLAN/PLMN discovery and selection.

### SUMMARY OF THE INVENTION

Embodiments of the present invention are directed to the selection of a wireless local area network in the case of a split user equipment. One exemplary embodiment of the present invention discloses a method, program product and system of selecting a wireless local area network (WLAN) using split user equipment. The method can comprise the following steps: a first user equipment obtains relevant network selection parameters from a second user equipment and obtains an undecorated root network access identifier from the second user equipment, the first user equipment performs network discovery and selection, and, upon initiation of final EAP authentication, the first user equipment decorates said network access identifier, according to the results of network discovery and selection, and transmits it to the WLAN.

In another exemplary embodiment, the present invention provides a method of selecting a wireless local area network (WLAN) using split user equipment. The method can comprise obtaining, by a first user equipment, relevant network selection parameters from a second user equipment; obtaining, by the first user equipment, an undecorated root network access identifier from the second user equipment; allowing a user to select a preferred WLAN; and upon initiation of final EAP authentication, decorating, by the first user equipment, the network access identifier and transmitting it to the selected WLAN.

Other features and advantages of the present invention will become apparent to those skilled in the art from the following detailed description. It should be understood, however, that the detailed description and specific examples, while indicating preferred embodiments of the present invention, are given by way of illustration and not limitation. Many changes and modifications within the scope of the present invention may be made without departing from the spirit thereof, and the invention includes all such modifications.

### BRIEF DESCRIPTION OF THE DRAWINGS

The foregoing advantages and features of the invention will become apparent upon reference to the following detailed description and the accompanying drawings, of which:

FIG. 1 is a flowchart illustrating basic selection of a WLAN under an exemplary embodiment of the present invention;

FIG. 2 is a diagram illustrating one possible message flow between various components of a system in which an exemplary embodiment of the present invention is implemented; and

FIG. 3 is a diagram illustrating a system that uses an exemplary embodiment of the present invention.

### DETAILED DESCRIPTION OF EXEMPLARY EMBODIMENTS

In an exemplary embodiment, the present invention provides a method of performing selection of a wire local area network (WLAN) in the split WLAN user equipment case. In the split WLAN user equipment case, the smart card and the WLAN network interface are attached to two separate devices, which are connected by a local link. For example, the split User Equipment (UE) may be a laptop and a phone or may be a Personal Digital Assistant (PDA) and a phone.

In the split laptop and phone case, the laptop can perform the WLAN radio network selection, because the network interface is included in the laptop. The WLAN interface can scan for available radio networks and can eventually selects the network to join. If VPLMN availability can affect the selection of the WLAN radio network, as in 3GPP WLAN interworking, then the laptop can include 3GPP specific code for 3GPP specific network selection.

If the laptop needs to have 3GPP specific functionality it can be advantageous to have the laptop be responsible for network discovery and network selection, even though network discovery and selection may use EAP and the EAP methods implemented by the phone.

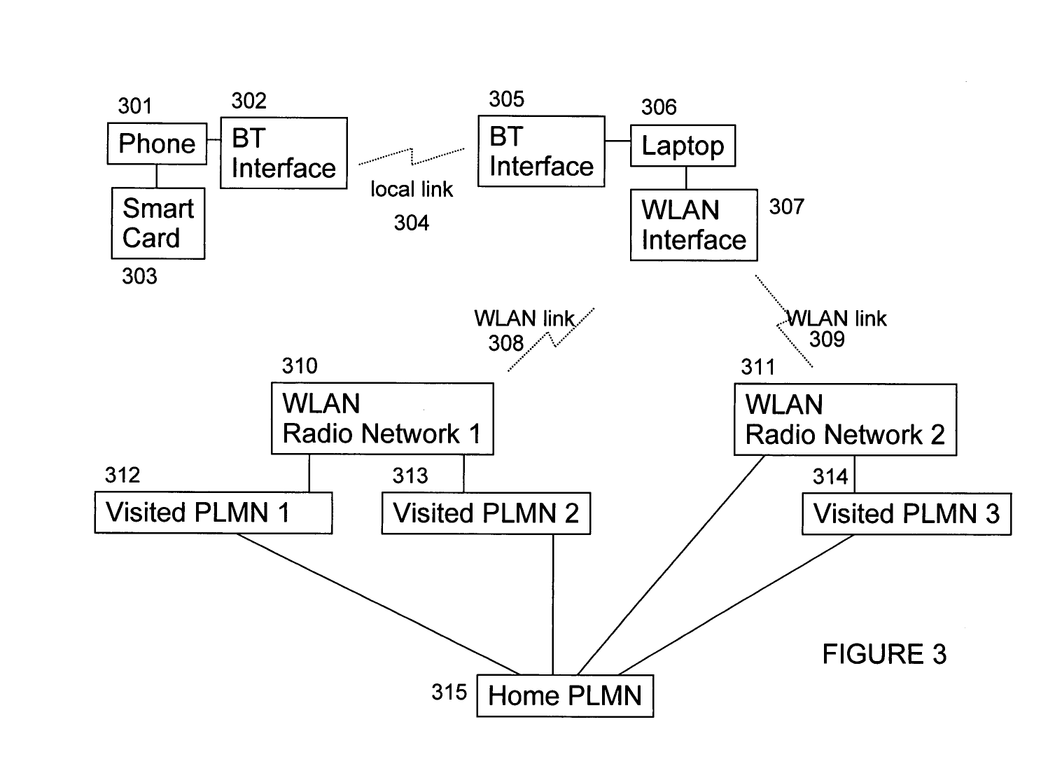

An example system where embodiments of the invention can be used is illustrated in FIG. 3. The phone 301 can be attached to a smart card 303 that contains the SIM or USIM functionality. The phone 301 also can have a communication interface, such as a Bluetooth interface 302, which it can be used to connect to the laptop 306. In this case, the laptop 306 also has a Bluetooth interface 305. Authentication information can be communicated between the phone 301 and the laptop 306 over the local Bluetooth link 304.

The laptop 306 can have a Wireless Local Area Network (WLAN) interface 307, which can associate with WLAN Radio Network 1 310 or WLAN Radio Network 2 311. In other words, there can be two separate WLAN radio networks available in the present location of the laptop 306. WLAN Radio Network 1 310 can be directly connected with Visited PLMN 1 312 and Visited PLMN 2 313. Both Visited PLMN 1 and Visited PLMN 2 can have connections to the user's home PLMN 315. WLAN Radio Network 2 311 can be directly connected with the home PLMN 315, and with Visited PLMN 3 314, which can also be connected with the home PLMN 315.

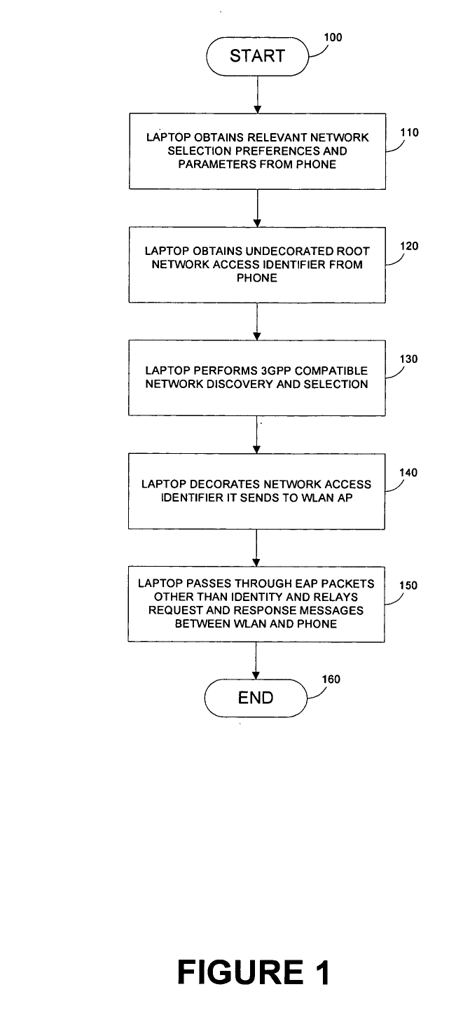

FIG. 1 is a flowchart illustrating basic selection of a WLAN under an exemplary embodiment of the present invention. In one embodiment of the invention, the network selection and EAP authentication exchange can work as follows, with reference to FIG. 1.

The process starts at element 100. As shown in step 110, a first user equipment, such as a laptop, may obtain relevant network selection preferences and parameters from a second user equipment, such as a telephone, over a communication link such as Bluetooth. In the exemplary system illustrated in FIG. 3, the information obtained might contain priorities of the visited PLMNs so that Visited PLMN1 should be preferred over other Visited PLMNs, and Visited PLMN2 over Visited PLMN3. This can be accomplished by any local communication link between the split user equipment and does not need to be limited to Bluetooth.

Then, as shown in step 120, the first user equipment (e.g., a laptop) obtains the undecorated root Network Access Identifier (EAP identity Response) from the second user equipment (e.g., the telephone) by using, for example, an EAP Identity Request.

Next, as shown in step 130, the first user equipment (e.g., the laptop) performs 3GPP compatible network discovery and network selection. The laptop may use user or operator preferences in the selection. Alternatively, manual network selection may be used, in which the user selects the preferred WLAN radio network and/or PLMN. In the example illustrated in FIG. 3, the laptop would learn that there are two WLAN radio networks available (WLAN Radio Network 1 310 and WLAN Radio Network 2 311), and the laptop would also learn which PLMNs are directly connected with each available WLAN radio network.

Next, as shown in step 140, when the final EAP authentication is initiated, the laptop may decorate the Network Access Identifier it sends to the WLAN AP as required. For example the laptop may indicate the selected visited PLMN by decorating the identity. In the example of FIG. 3, the laptop would likely select the WLAN Radio Network 2 311, because the home PLMN is directly available via the WLAN Radio Network 2. In this case, there would be no need to decorate the NAI because intermediate AAA hops are not present between the WLAN radio network and the home PLMM. If only WLAN Radio Network 1 310 was available, then the laptop would select the more preferred Visited PLMN 1 312, and compose a decorated NAI that indicated AAA routing via Visited PLMN 1.

Traditionally, the network access identifier (NAI) consisted of two parts: a username, which identifies the user within a realm, and a realm, which identifies the home organization. For example, fred@3com.com would be a valid NAI. In this example, the username is “fred” and the realm is “3com.com”. Network access identifiers that are formed in this manner are often called “root” Network Access Identifiers or “undecorated” Network Access Identifiers, because they do not contain any additional information besides the username and the home realm.

Later on, the need to indicate supplementary AAA routing information was identified. AAA stands for Authentication, Authorization and Accounting. In a system such as the one shown in FIG. 3, there are several AAA routes to the home organization. A root NAI would only indicate the desired destination and would not indicate which route should be used in the AAA communications. “Decoration” refers to adding extra portions to the root NAI or otherwise modifying the root NAI in order to indicate which mediating network should be used in the AAA communications. In the example of FIG. 3, a decorated NAI might, for example, indicate that AAA packets should be routed via Visited PLMN 1.

Thus, the root NAI can be modified to indicate an intermediate AAA hop—instead of user@homerealm, an NAI of the format homerealm!user@otherrealm may be used. The latter format is often called a decorated NAI.

In addition, an exemplary embodiment of the invention can also include step 150. If the EAP peer is completely implemented by the second user equipment (e.g., telephone), then for other EAP packets besides EAP identity, the first user equipment (e.g., the laptop) may act as a pass-though and only relays EAP request and response messages between the WLAN network and the second user equipment.

If EAP-SIM or EAP-AKA authentication protocols are used, then the 3GPP AAA server always re-requests the undecorated peer identity from the EAP-SIM/AKA peer using EAP-SIM/AKA attributes, in order to ensure that key derivation works correctly.

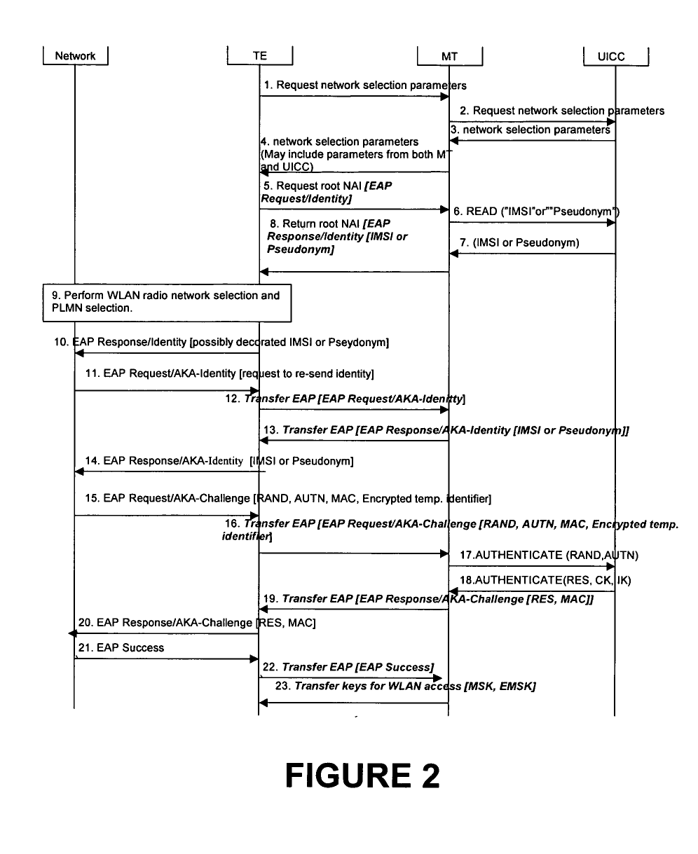

FIG. 2 illustrates the message flow between various components of a system in which an exemplary embodiment of the present invention is implemented. The procedure described above is illustrated in detail in FIG. 2, using EAP-AKA as an example. EAP-SIM would be very similar to the procedure illustrated. Steps 1-10 of FIG. 2 could be the same as EAP-AKA or any other EAP method. The present invention is not specific to EAP-SIM or EAP-AKA, but it could work similarly with any EAP method.

Step 1. First user equipment (eg. laptop—terminal equipment) requests network selection information from the second user equipment (e.g. telephone—mobile terminal).

Step 2. Second user equipment (telephone) requests network selection information from the smart card (UICC).

Step 3. Smart card returns network selection information to second user equipment (telephone).

Step 4. Second user equipment (telephone) returns network selection information to first user equipment (laptop—may contain parameters from both phone and smart card).

Step 5. First user equipment (laptop) requests the undecorated root identity from the second user equipment (telephone).

Step 6. Second user equipment (telephone) reads the identity from the smart card.

Step 7. Smart card returns identity to second user equipment (telephone).

Step 8. Second user equipment (telephone) returns identity to first user equipment (laptop).

Step 9. Second user equipment (laptop) performs network selection as usual according to the 3GPP WLAN network selection principles. During network discovery, the laptop receives EAP Identity Request messages and may transmit several EAP identity response messages.

Step 10. Eventually, the first user equipment (laptop) sends the last EAP Identity response message. The user identity the first user equipment (laptop) received from the second user equipment (telephone) could need to be decorated according to the discovered network information.

Steps 11-14. During the first round of the EAP-AKA exchange, the network re-requests the user identity and receives an undecorated copy, as specified in EAP-AKA.

Steps 15-22. The second round of the EAP-AKA exchange is the actual mutual authentication, as specified in EAP-AKA. Successful authentication ends with the receipt of the EAP-Success packet.

Step 23. The second user equipment (telephone) sends the keying material to the first user equipment (laptop).

In conclusion, the exemplary embodiments of the present invention provide at least the following important advantages over existing systems. First, 3GPP compatible WLAN network discovery can be supported in the split UE case. Second, there are no dependencies between the communication (Bluetooth) interface and WLAN network discovery procedures, so the communication interface does not have to be changed when new WLAN network discovery methods are deployed

As noted above, embodiments within the scope of the present invention include program products comprising computer-readable media for carrying or having computer-executable instructions or data structures stored thereon. Such computer-readable media can be any available media that can be accessed by a general purpose or special purpose computer. By way of example, such computer-readable media can comprise RAM, ROM, EPROM, EEPROM, CD-ROM or other optical disk storage, magnetic disk storage or other magnetic storage devices, or any other medium which can be used to carry or store desired program code in the form of computer-executable instructions or data structures and which can be accessed by a general purpose or special purpose computer. When information is transferred or provided over a network or another communications connection (either hardwired, wireless, or a combination of hardwired or wireless) to a computer, the computer properly views the connection as a computer-readable medium. Thus, any such connection is properly termed a computer-readable medium. Combinations of the above are also to be included within the scope of computer-readable media. Computer-executable instructions comprise, for example, instructions and data which cause a general purpose computer, special purpose computer, or special purpose processing device to perform a certain function or group of functions.

The invention is described in the general context of method steps, which may be implemented in one embodiment by a program product including computer-executable instructions, such as program code, executed by computers in networked environments. Generally, program modules include routines, programs, objects, components, data structures, etc. that perform particular tasks or implement particular abstract data types. Computer-executable instructions, associated data structures, and program modules represent examples of program code for executing steps of the methods disclosed herein. The particular sequence of such executable instructions or associated data structures represents examples of corresponding acts for implementing the functions described in such steps.

Software and web implementations of the present invention could be accomplished with standard programming techniques with rule based logic and other logic to accomplish the various database searching steps, correlation steps, comparison steps and decision steps. It should also be noted that the words “component” and “module” as used herein and in the claims is intended to encompass implementations using one or more lines of software code, and/or hardware implementations, and/or equipment for receiving manual inputs.

The foregoing description of embodiments of the present invention has been presented for purposes of illustration and description. It is not intended to be exhaustive or to limit the present invention to the precise form disclosed, and modifications and variations are possible in light of the above teachings or may be acquired from practice of the present invention. The embodiments were chosen and described in order to explain the principals of the present invention and its practical application to enable one skilled in the art to utilize the present invention in various embodiments and with various modifications as are suited to the particular use contemplated.

1. A method of selecting a network using split user equipment, the method comprising:
a first user equipment obtains relevant network selection parameters from a second user equipment;
the first user equipment obtains an undecorated root network access identifier from the second user equipment;
the first user equipment performs network discovery and selection; and
the first user equipment decorates the network access identifier and transmits it to the selected network.

2. The method of claim 1 further comprising the first user equipment passing EAP packets from the selected network through to the second user equipment.

3. The method of claim 1 wherein obtaining an undecorated root network access identifier further comprises using an EAP identity request.

4. The method of claim 1 wherein obtaining the relevant network selection parameters further comprises:
the first user equipment requesting network selection parameters from the second user equipment;
the second user equipment requesting network selection parameters from memory;
the memory returning the requested network selection parameters for the second user equipment; and
the second user equipment forwarding the returned network selection parameters for the first user equipment.

5. The method of claim 1 wherein the network is a wireless local area network (WLAN).

6. The method of claim 1 wherein during network discovery, the first user equipment received EAP Identity Request messages and transmits EAP identity response messages.

7. The method of claim 5 wherein the first user equipment performs network selection according to 3GPP WLAN network selection principles.

8. A method of selecting a network using split user equipment, the method comprising:
obtaining, by a first user equipment, relevant network selection parameters from a second user equipment;
obtaining, by said first user equipment, an undecorated root network access identifier from the second user equipment;
allowing a user to select a preferred network; and
decorating, by said first user equipment, said network access identifier and transmitting it to the selected network.

9. The method of claim 8 further comprising the first user equipment passing EAP packets from the selected network through to the second user equipment.

10. The method of claim 8 further comprising the first user equipment performing network discovery.

11. The method of claim 8 wherein obtaining an undecorated root network access identifier further comprises using an EAP identity request.

12. The method of claim 8 wherein obtaining the relevant network selection parameters further comprises:
the first user equipment requesting network selection parameters from the second user equipment;
the second user equipment requesting network selection parameters from memory;
the memory returning the requested network selection parameters for the second user equipment; and
the second user equipment forwarding the returned network selection parameters for the first user equipment.

13. The method of claim 8 wherein the network is a wireless local area network (WLAN).

14. The method of claim 10 wherein during network discovery, the first user equipment received EAP Identity Request messages and transmits EAP identity response messages.

15. The method of claim 14 wherein the first user equipment performs network selection according to 3GPP WLAN network selection principles.

16. A program product for selecting a network using split user equipment, said program product containing machine readable program code for causing, when executed, one or more machines to perform the following:
a first user equipment obtains relevant network selection parameters from a second user equipment;
the first user equipment obtains an undecorated root network access identifier from the second user equipment;
the first user equipment performs network discovery and selection; and
the first user equipment decorates the network access identifier and transmits it to the selected network.

17. The program product of claim 16 further comprising program code for causing the first user equipment to pass EAP packets from the selected network through to the second user equipment.

18. The program product of claim 16 wherein obtaining an undecorated root network access identifier further comprises using an EAP identity request.

19. The program product of claim 16 wherein the network is a wireless local area network (WLAN).

20. The program product of claim 16 wherein during network discover, the first user equipment receives EAP Identity Request messages and transmits EAP identity response messages.

21. The method of claim 20 wherein the first user equipment performs network selection according to 3GPP WLAN network selection principles.

22. A system for selecting a network using split user equipment, the system comprising:
a first user equipment;
a second user equipment;
the first user equipment being configured to obtain relevant network selection parameters from the second user equipment;
the first user equipment being further configured to obtain an undecorated root network access identifier from the second user equipment;
the first user equipment being further configured to perform network discovery and selection; and
the first user equipment being further configured to decorate the network access identifier and transmit it to the selected network.
